(19) United States
(12) Patent Application Publication
(10) Pub. No.: US 2020/0104342 A1
(43) Pub. Date: Apr. 2, 2020

(54) CONTENT PROVIDING SYSTEM THAT PROVIDES DOCUMENT AS REFERENCE FOR EDITING, CONTENT PROVIDING METHOD, INFORMATION PROCESSING APPARATUS, AND STORAGE MEDIUM

(71) Applicant: CANON KABUSHIKI KAISHA, Tokyo (JP)

(72) Inventor: Soshi Oshima, Tokyo (JP)

(21) Appl. No.: 16/565,929

(22) Filed: Sep. 10, 2019

(30) Foreign Application Priority Data
Sep. 28, 2018 (JP) 2018-184591

(51) Int. Cl. G06F 17/21; G06K 9/00; G06F 17/24

(52) U.S. Cl. CPC G06F 17/211; G06F 17/24; G06K 9/00456

(57) ABSTRACT

A content providing system which is capable of providing a user with data whose contents are similar to those of partial data being edited by the user. The content providing system provides a content registered in advance to an information processing apparatus being operated by the user. Plural pieces of partial data constituting the registered content are analyzed, and each piece of the partial data is managed in association with any of a plurality of predetermined clusters. A cluster into which displayed partial data displayed on the information processing apparatus is classified is determined, and partial data associated with the determined cluster among the plural pieces of partial data constituting the registered content is provided to the information processing apparatus.

### BACKGROUND OF THE INVENTION

### Field of the Invention

The present invention relates to a content providing system, a content providing method, an information processing apparatus, and a storage medium.

### Description of the Related Art

A content providing system which, while a user is editing a document with office software or the like, provides another document as a reference for editing is known. The content providing system determines a cluster into which a document input by a user (hereafter referred to as “the input document”) is classified, and provides a document having a high similarity to the determined cluster among documents registered in advance in a database to the user (see Japanese Laid-Open Patent Publication (Kokai) No. 2008-158590). As a result, the document whose contents are similar to those of the input document is provided to the user, which helps the user edit the input document.

However, in the conventional content providing system, clusters for classification are determined on a document-by-document basis, and hence data whose contents are similar to those of partial data such as a page or a chapter being edited by the user cannot be provided to the user.

### SUMMARY OF THE INVENTION

The present invention provides a content providing system, a content providing method, an information processing apparatus, which are capable of providing a user with data whose contents are similar to those of partial data being edited by the user, as well as a storage medium.

Accordingly, the present invention provides a content providing system that provides a content registered in advance to an information processing apparatus that is operated by a user, comprising at least one processor and/or a circuit configured to function as an analysis unit that analyzes plural pieces of partial data constituting the registered content, a management unit that manages each piece of the partial data in association with any of a plurality of predetermined clusters, a cluster determination unit that determines a cluster into which displayed partial data displayed on the information processing apparatus is classified, and a content providing unit that provides partial data associated with the determined cluster among the plural pieces of partial data constituting the registered content to the information processing apparatus.

According to the present invention, data whose contents are similar to those of partial data being edited by the user is provided to the user.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of a content providing system according to an embodiment of the present invention.

FIG. 2A is a block diagram schematically showing a hardware arrangement of a control device provided in a content analysis server in FIG. 1.

FIG. 2B is a block diagram schematically showing a hardware arrangement of a control device provided in a terminal apparatus in FIG. 1.

FIG. 3A is a block diagram schematically showing a functional arrangement of the content analysis server in FIG. 1.

FIG. 3B is a block diagram schematically showing a functional arrangement of the terminal apparatus in FIG. 1.

FIGS. 4A and 4B are views useful in explaining how recommendation images are displayed on the terminal apparatus in FIG. 1.

FIG. 5 is a flowchart showing the procedure of a clustering process which is carried out by a document analysis module in FIG. 3.

FIG. 6 is a view useful in explaining how features of page data are vectorized in the clustering process in FIG. 5.

FIG. 7 is a view showing an example of a partial data information management table which is managed by the content analysis server in FIG. 1.

FIG. 8 is a flowchart showing the procedure of a display control process which is carried out by the terminal apparatus in FIG. 1.

FIG. 9 is a flowchart showing the procedure of a recommendation image generating process which is carried out by the content analysis server in FIG. 1.

FIG. 10 is a view useful in explaining how a cluster is determined in step S903 in FIG. 9.

FIG. 11 is a view useful in explaining how objects to be recommended are selected in step S904 in FIG. 9.

FIGS. 12A, 12B, and 12C are views useful in explaining examples of recommendation images which are displayed by the terminal apparatus in FIG. 1.

FIG. 13 is a flowchart showing the procedure of a variation of the clustering process in FIG. 5.

FIG. 14 is a view showing an example of a document information management table which is managed by the content analysis server in FIG. 1.

FIG. 15 is a flowchart showing the procedure a variation of the recommendation image generating process in FIG. 9.

### DESCRIPTION OF THE EMBODIMENTS

An embodiment of the present invention will now be described in detail with reference to the drawings.

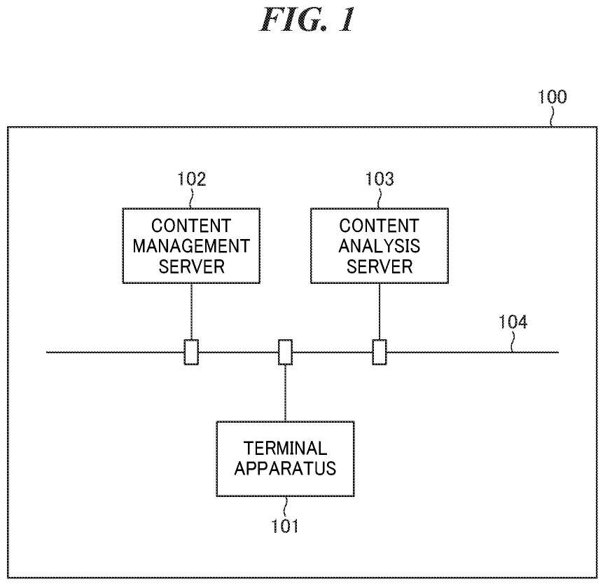

FIG. 1 is a block diagram schematically showing an arrangement of a content providing system 100 according to an embodiment of the present invention. Referring to FIG. 1, the content providing system 100 has a terminal apparatus 101, which is an information processing apparatus, a content management server 102, and a content analysis server 103. It should be noted that for ease of explanation, the content providing system 100 is configured to be equipped with one terminal apparatus 101 in the present embodiment, one content management server 102, and one content analysis server 103, but the number of apparatuses is not limited to this. For example, the content providing system 100 may be equipped with a plurality of terminal apparatuses 101, content management servers 102, and content analysis servers 103. The terminal apparatus 101, the content management server 102, and the content analysis server 103 are capable of carrying out data communications via a network 104. The network 104 is the Internet, a wired LAN, a wireless LAN, or a combination of them. The terminal apparatus 101, the content management server 102, and the content analysis server 103 are connected to the network 104 directly or via connecting equipment (not shown). The connecting equipment is, for example, a router, a gateway, or a proxy server.

The terminal apparatus 101 is a terminal that is directly operated by a user. The user operates the terminal apparatus 101 to edit a document using office software or the like. The content management server 102 manages a plurality of registered contents. The content management server 102 manages contents with different types of data structures, for example, a document comprised of a plurality of pages, a document comprised of a plurality of chapters, a document comprised of a plurality of sections, and a document comprised of a plurality of paragraphs. The content analysis server 103 analyzes documents managed by the content management server 102 and documents transmitted from the terminal apparatus 101. In the content providing system 100, among documents managed by the content management server 102, documents with high similarities to a document that is being worked on by the user is provided to the terminal apparatus 101. In the following description, data selected so as to be provided to the terminal apparatus 101 will be referred to as recommendation data.

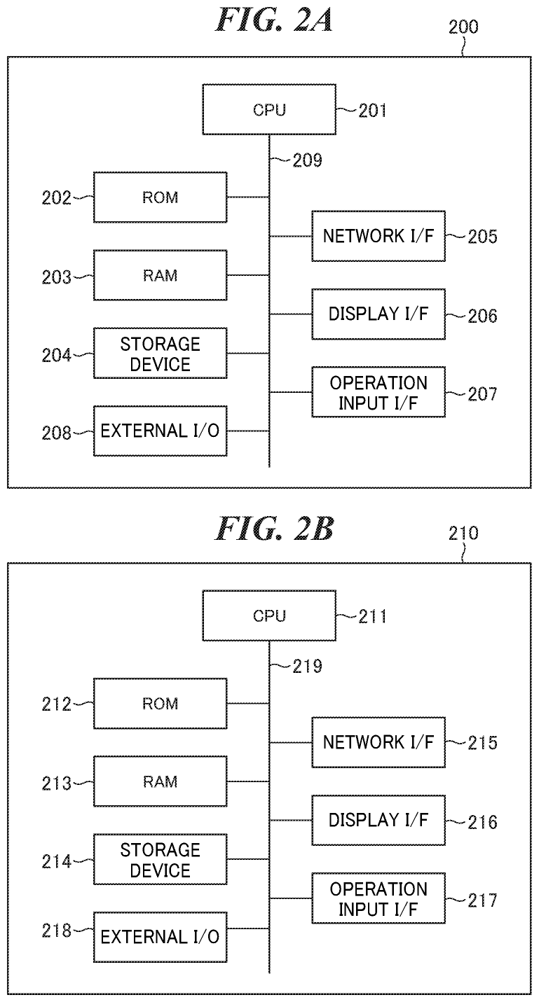

FIG. 2A is a block diagram schematically showing a hardware arrangement of a control device 200 provided in the content analysis server 103 in FIG. 1. FIG. 2B is a block diagram schematically showing a hardware arrangement of a control device 210 provided in the terminal apparatus 101 in FIG. 1.

Referring to FIG. 2A, the control device 200 has a CPU 201, a ROM 202, a RAM 203, a storage device 204, a network I/F 205, a display I/F 206, an operation input I/F 207, and an external I/O 208. The CPU 201, the ROM 202, the RAM 203, the storage device 204, the network I/F 205, the display I/F 206, the operation input I/F 207, and the external I/O 208 are connected to one another via a system bus 209.

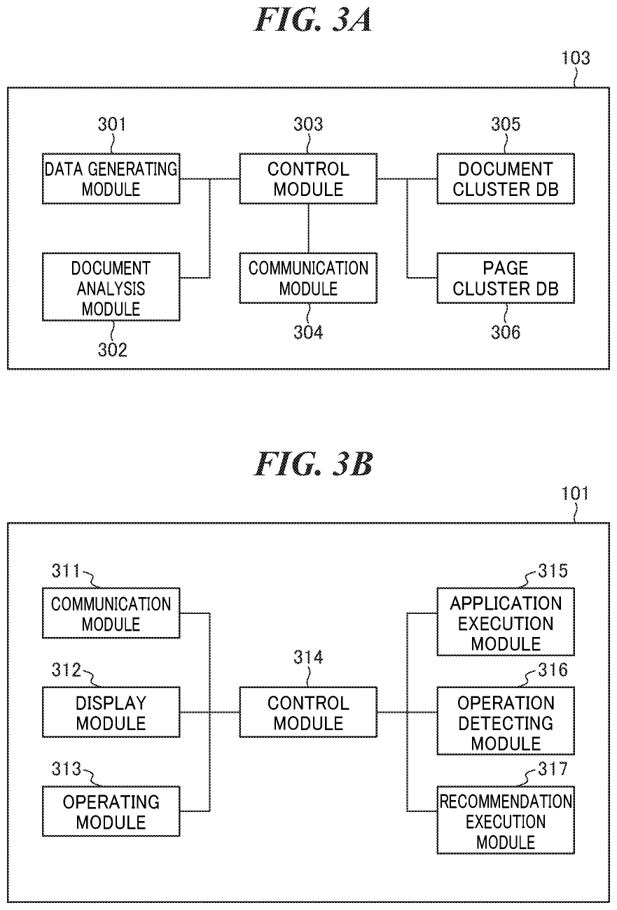

The control device 200 integratedly controls the entire content analysis server 103. The CPU 201 controls various processes by executing programs stored in the ROM 202. The ROM 202 stores programs, which are executed by the CPU 201, and setting data. The RAM 203 is used as a work area for the CPU 201 and also as a temporary storage area for each piece of data. The storage device 204 stores, for example, programs for controlling modules in FIG. 3A, which will be described later. The network I/F 205 controls data communications with external apparatuses connected via the network 104, for example, the terminal apparatus 101 and the content management server 102. An external display (not shown) such as a liquid crystal display is connected to the display I/F 206. Operation input equipment (not shown) such as a keyboard, a mouse, and a touch panel is connected to the operation input I/F 207. A USB memory, an external storage device, and so forth are connected to the external I/O 208.

Referring to FIG. 2B, the control device 210 has a CPU 211, a ROM 212, a RAM 213, a storage device 214, a network I/F 215, a display I/F 216, an operation input I/F 217, and an external I/O 218. The CPU 211, the ROM 212, the RAM 213, the storage device 214, the network I/F 215, the display I/F 216, the operation input I/F 217, and the external I/O 218 are connected to one another via a system bus 219.

The control device 210 integratedly controls the entire terminal apparatus 101. The CPU 211 controls various processes by executing programs stored in the ROM 212. The ROM 212 stores programs, which are executed by the CPU 211, and setting data. The RAM 213 is used as a work area for the CPU 211 and also as a temporary storage area for each piece of data. The storage device 214 stores, for example, programs for controlling modules in FIG. 3B, which will be described later. The network I/F 215 controls data communications with external apparatuses connected via the network 104, for example, the content management server 102 and the content analysis server 103. An external display (not shown) such as a liquid crystal display is connected to the display I/F 216. Operation input equipment (not shown) such as a keyboard, a mouse, and a touch panel is connected to the operation input I/F 217. A USB memory, an external storage device, and so forth are connected to the external I/O 218.

FIG. 3A is a block diagram schematically showing a functional arrangement of the content analysis server 103 in FIG. 1. FIG. 3B is a block diagram schematically showing a functional arrangement of the terminal apparatus 101 in FIG. 1.

Referring to FIG. 3A, the content analysis server 103 has a data generating module 301, a document analysis module 302, a control module 303, a communication module 304, a document cluster DB 305, and a page cluster DB 306. Processes in the modules mentioned above are implemented by the CPU 201 executing programs stored in the ROM 202 and the storage device 204.

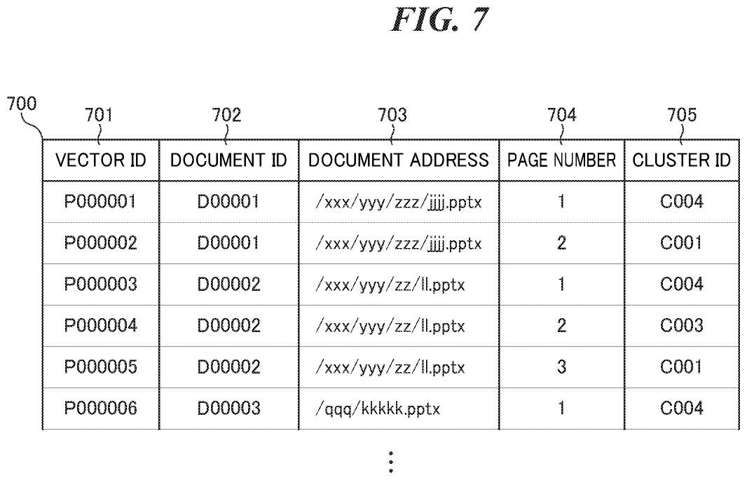

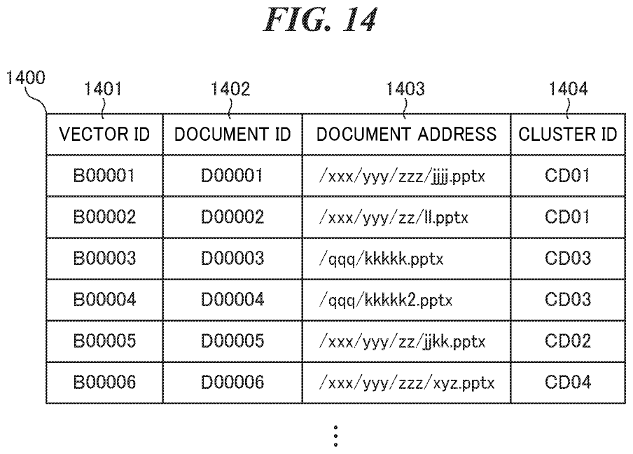

The data generating module 301 generates recommendation display data for displaying images, which represent recommendation data, on the terminal apparatus 101. The recommendation display data includes thumbnails (hereafter referred to as “recommendation images”) of recommendation data, page numbers of the recommendation data, and addresses indicating storage locations of the recommendation data. The document analysis module 302 analyzes structures of documents. For example, the document analysis module 302 analyzes page information of all documents managed by the content management server 102. The document analysis module 302 also analyzes a structure of a document which is being edited by the user with the terminal apparatus 101. The control module 303 controls the control device 200 and equipment connected to the control device 200. The control module 303 also controls execution of processes in the above described modules of the content analysis server 103. The communication module 304 controls data communications with the external apparatuses connected to the network 104. The document cluster DB 305 manages a document information management table 1400 in FIG. 14, which will be described later. The page cluster DB 306 manages a partial data information management table 700 in FIG. 7, which will be described later.

Referring to FIG. 3B, the terminal apparatus 101 has a communication module 311, a display module 312, an operating module 313, a control module 314, an application execution module 315, an operation detecting module 316, and a recommendation execution module 317. Processes in these modules of the terminal apparatus 101 are implemented by the CPU 211 executing programs stored in the ROM 212 and the storage device 214.

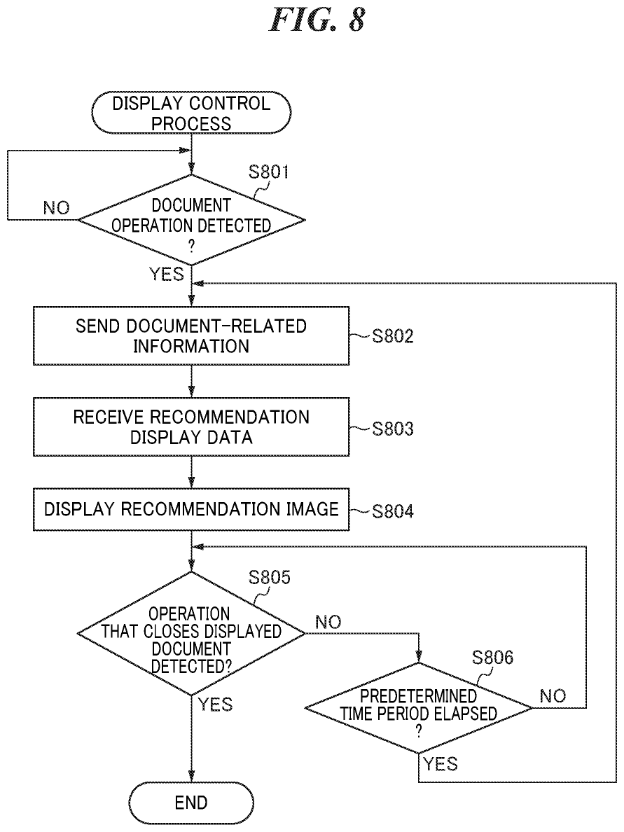

The communication module 311 controls data communications with the external apparatuses connected to the network 104. For example, the communication module 311 receives recommendation display data, which will be described later, from the content analysis server 103. The communication module 311 also obtains recommendation data from the content management server 102. The display module 312 controls display on the display (not shown) of the terminal apparatus 101. The operating module 313 receives instructions input via the operation input equipment (not shown) such as a keyboard, a mouse, and a touch panel connected to the terminal apparatus 101. The control module 314 controls the control device 210 and equipment connected to the control device 210. The control module 314 also controls execution of processes in the above described modules of the terminal apparatus 101. The application execution module 315 executes applications installed in the terminal apparatus 101. The operation detecting module 316 detects user's operations on the terminal apparatus 101 based on instructions received via the operation input equipment, statuses of the applications executed by the application execution module 315. The recommendation execution module 317 carries out a display control process in FIG. 8, which will be described later.

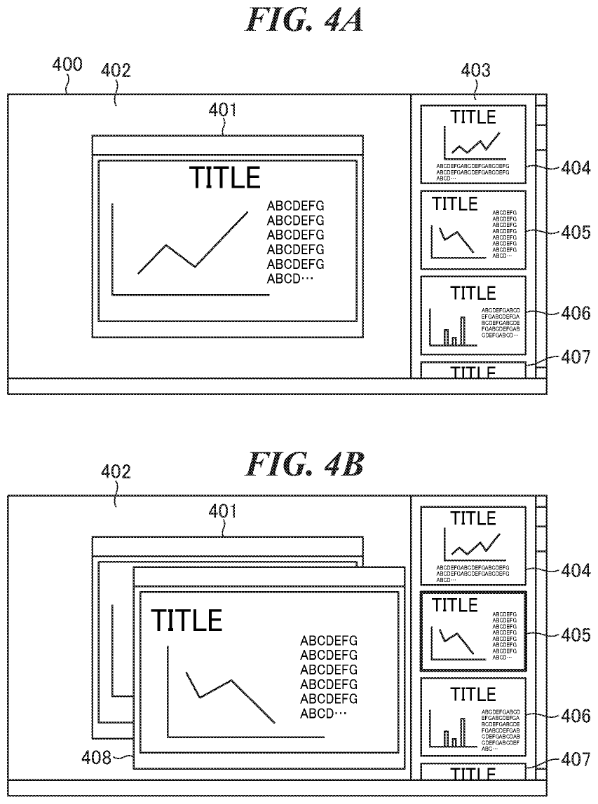

FIGS. 4A and 4B are views useful in explaining how recommendation images are displayed on the terminal apparatus 101 in FIG. 1.

A screen 400 in FIG. 4A is a schematic representation of a screen displayed on the display (not shown) of the terminal apparatus 101. In the terminal apparatus 101, when a recommendation data obtaining application for obtaining recommendation data is started, a window 401 is displayed on the screen 400. The window 401 is a window of application software which is run on the terminal apparatus 101 and capable of displaying and editing a document. The user views and edits a document through the window 401. In the following description, a document that is displayed in the window 401 so as to be viewed and edited will be referred to as a displayed document (displayed content). When the user performs an operation to open a document, the screen 400 is split into a region 402 where the window 401 is displayed and a region 403 where recommendation images 404 to 407 are displayed. The recommendation images 404 to 407 are thumbnails of page data with high similarities to page data (hereafter referred to as “displayed page data”) (displayed partial data), which is displayed in the window 401, among plural pieces of page data constituting a document managed by the content management server 102. In the region 403, a plurality of recommendation images is displayed, and a recommendation image that does not fit into the region 403 can be displayed by scrolling it with a mouse (not shown) or the like.

FIG. 4B shows a state in which the user has selected the recommendation image 405 with the mouse or the like. A frame of the selected recommendation image 405 is, for example, highlighted as shown in FIG. 4B. A window 408 is for displaying page data (recommendation data) corresponding to the recommendation image 405 after the user selects the recommendation image 405. Thus, in the present embodiment, by selecting a recommendation image, the user can display page data (recommendation data) corresponding to the selected recommendation image on the screen 400. The user uses the recommendation data as a reference or a material when editing the displayed page data.

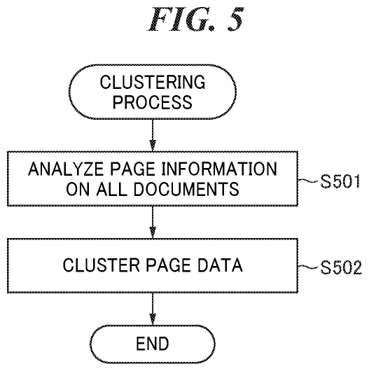

FIG. 5 is a flowchart showing the procedure of a clustering process which is carried out by the document analysis module 302 in FIG. 3. The process in FIG. 5 is implemented by the CPU 201 executing a program stored in the ROM 202 or the storage device 204. The clustering process in FIG. 5 is carried out, for example, when a new document is registered in the content management server 102 or when a predetermined time period set in advance has elapsed.

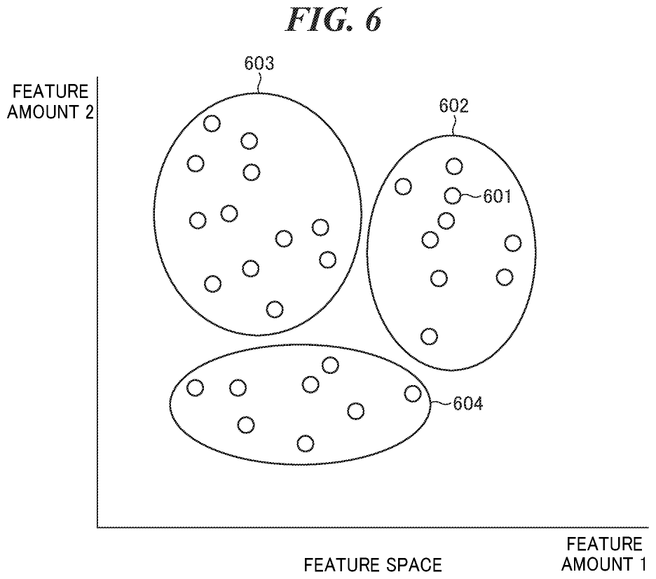

Referring to FIG. 5, first, the document analysis module 302 analyzes page information on all documents that are managed by the content management server 102 (step S501). Specifically, the document analysis module 302 obtains page information on each document from structure information on the documents and extracts text data of each piece of page data. The document analysis module 302 also vectorizes features of each piece of the page data based on the extracted text data. In the present embodiment, the features of each piece of the page data are vectorized using Doc2Vec or the like. FIG. 6 is a view schematically showing how the features of each piece of the vectored page data are plotted in a feature space. It should be noted that the feature space is defined with an N-dimensional (N is an integer) basis vector being an axis, but in the present embodiment, for ease of explanation, it is assumed that the feature space is a two-dimensional space with feature amounts 1 and 2. In FIG. 6, white circles such as a vector 601 represent feature vectors obtained by vectorizing the features of each piece of the page data. The correspondences between the page data and the documents are managed in the partial data information management table 700 in FIG. 7. The partial data information management table 700 is comprised of vector IDs 701, document IDs 702, document addresses 703, page numbers 704, and cluster IDs 705. Identifiers for identifying respective feature vectors are recorded as the vector IDs 701. Identifiers for identifying respective documents managed by the content management server 102 are recorded as the document IDs 702. Addresses indicating storage locations of the documents managed by the content management server 102 are recorded as the document addresses 703. Page numbers of the documents are recorded as the page numbers 704. Identifiers for identifying results of clustering in step S502, and more specifically, identifying respective clusters with which page data corresponding to the page numbers is associated are recorded as the cluster IDs 705.

Next, the document analysis module 302 clusters the feature vectors of the page data obtained by vectorization in the step S501 (step S502). The K-means method, the X-means method, the minimum distance method, the Ward method, or the like is used for clustering. In FIG. 6, frames 602 to 604 represent clusters, and for example, feature vectors in the frame 602 belong to the same cluster. The results of clustering are recorded in the column of the cluster IDs 705 in the management table 701. Thus, in the present embodiment, each piece of page data of the document managed by the content management server 102 is associated with any of a plurality of clusters. After that, the document analysis module 302 ends the present process.

FIG. 8 is a flowchart showing the procedure of the display control process which is carried out by the terminal apparatus 101 in FIG. 1. The process in FIG. 8 is implemented by the CPU 211 executing a program stored in the ROM 212 or the storage device 214.

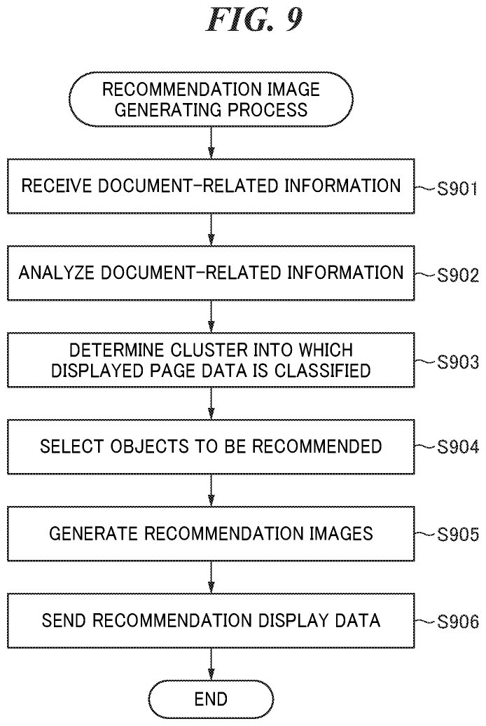

Referring to FIG. 8, the CPU 211 determines whether or not the operation detecting module 316 has detected a user's operation on a document (hereafter referred to as “the document operation”) (step S801). Specifically, the document operation is an operation for opening a document. The operating module 313 provides the control module 314 with information on the document operation in real time, and the control module 314 that has received the notification notifies the operation detecting module 316 that the document operation has been performed. When the operation detecting module 316 detects the document operation based on this notification (YES in the step S801), the CPU 211 sends information on a displayed document on which the document operation has been detected (hereafter referred to as “the document-related information”) to the content analysis server 103 via the communication module 311 (step S802). The document-related information includes information indicating the displayed document and a page number of displayed page data. The content analysis server 103 that has received the document-related information carries out a recommendation image generating process in FIG. 9, which will be described later. In the recommendation image generating process, the content analysis server 103 generates a recommendation image of page data with high similarities to feature amounts of the displayed page data and sends recommendation display data including the recommendation image to the terminal apparatus 101. The recommendation display data includes a page number of recommendation data and an address indicating a storage location of the recommendation data, as well as the recommendation image.

Then, the CPU 211 receives the recommendation display data from the content analysis server 103 (step S803) and displays the recommendation image, which is included in the recommendation display data, in the region 403 of the screen 400 (step S804). When the user selects the recommendation image displayed in the region 403, the CPU 211 accesses the address included in the recommendation display data to obtain the recommendation data indicated by the address. The CPU 211 also displays a new window in which the obtained recommendation data is displayed, for example, the window 408 in the region 402. The CPU 211 then determines whether or not an operation that closes the displayed document has been detected (step S805).

As a result of the determination in the step S805, when the operation that closes the displayed document has not been detected, the CPU 211 determines whether or not a predetermined time period set in advance has elapsed since the document-related information was sent in the step S802 (step S806). The predetermined time period is, for example, several minutes.

When the CPU 211 determines in the step S806 that the predetermined time period has not elapsed since the document-related information was sent in the step S802, the process returns to the step S805. When the CPU 211 determines in the step S806 that the predetermined time period has elapsed since the document-related information was sent in the step S802, the process returns to the step S802. Namely, in the present embodiment, when the predetermined time period set in advance has elapsed since the document-related information was sent to the content analysis server 103, other document-related information including the displayed page data displayed on the screen 400 is sent to the content analysis server 103.

As a result of the determination in the step S805, when the operation that closes the displayed document has been detected, the CPU 211 ends the present process.

FIG. 9 is a flowchart showing the procedure of the recommendation image generating process which is carried out by the content analysis server 103 in FIG. 1. The process in FIG. 9 is implemented by the CPU 201 executing a program stored in the ROM 202 or the storage device 204.

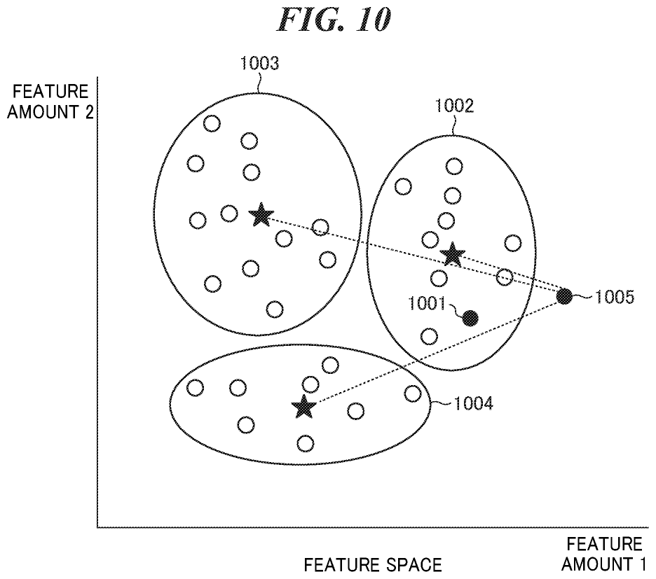

Referring to FIG. 9, the CPU 201 receives the document-related information sent from the terminal apparatus 101 in the step S802 (step S901). Next, the CPU 201 analyzes the document-related information (step S902). Specifically, the CPU 201 causes the document analysis module 302 to extract text data of the displayed page data identified from the page number included in the document-related information, and based on the extracted text data, vectors features of the displayed page data. It should be noted that the CPU 201 vectors the features in the same way as in the step S501. Then, based on the partial data information management table 700, the CPU 201 determines a cluster into which the displayed page data is classified (step S903). For example, when the feature vector of the displayed page data is a vector 1001 in FIG. 10, the CPU 201 determines that a cluster 1002 including the vector 1001 is the cluster into which the displayed page data is classified. When the feature vector of the displayed page data is a vector 1005 that is not included in any of clusters 1002 to 1004, the CPU 201 determines the cluster into which the displayed page data is classified based on distances to centers of the respective clusters 1002 to 1004. In this case, the CPU 201 determines that among the clusters 1002 to 1004, the cluster 1002 whose center is the closest to the vector 1005 is the cluster into which the displayed page data is classified.

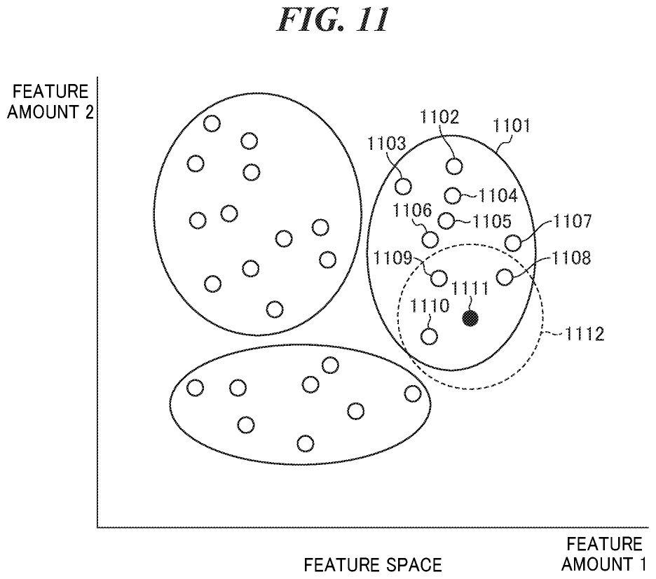

Then, from plural pieces of page data constituting the documents managed by the content management server 102, the CPU 201 selects page data associated with the determined cluster as objects to be recommended (step S904). In the step S904, for example, all page data corresponding to vectors 1102 to 1110 in a determined cluster 1101 in FIG. 11 is selected as objects to be recommended. Alternatively, of the vectors 1102 to 1110 in the determined cluster 1101, page data corresponding to the vectors 1108 to 1110 within a region 1112 whose center is a vector 1111 of the displayed page data and which is concentric with the vector 1111 is selected as objects to be recommended. The page data corresponding to the vectors 1108 to 1110 is page data having extremely high similarities to the displayed page data.

The CPU 201 then generates recommendation images which are thumbnails of the objects to be recommended (step S905). Specifically, the CPU 201 causes the data generating module 301 to obtain addresses and page numbers of the selected objects to be recommended from the partial data information management table 700. The CPU 201 causes the data generating module 301 to generate recommendation images by creating thumbnails of page data indicated by the obtained addresses among plural pieces of page data constituting the documents managed by the content management server 102. The CPU 201 then sends recommendation display data including the recommendation images, page numbers of recommendation data and addresses indicating storage locations of recommendation data to the terminal apparatus 101 (step S906) and ends the present process.

According to the embodiment described above, among plural pieces of page data constituting documents managed by the content management server 102, page data associated with a cluster into which displayed page data is classified is provided to the terminal apparatus 101. As a result, recommendation data whose contents are similar to those of the displayed page data being edited is provided to the user.

Moreover, according to the embodiment described above, among plural pieces of page data constituting documents managed by the content management server 102, recommendation images which are thumbnails of recommendation data associated with a cluster into which displayed page data is classified are provided to the terminal apparatus 101. As a result, the user easily selects recommendation data suitable as a reference for editing from the displayed recommendation images.

According to the embodiment described above, the terminal apparatus 101 displays recommendation images (see, for example, the recommendation images 404 to 407 in FIG. 4) of page data corresponding to document-related information including information on displayed page data among plural pieces of page data constituting documents managed by the content management server 102 and obtains page data (recommendation data) corresponding to the recommendation images. Thus, the recommendation data whose contents are similar to those of the displayed page data being edited is provided to the user.

Moreover, according to the embodiment described above, when the predetermined time period set in advance has elapsed since document-related information was sent to the content analysis server 103, other document-related information indicating displayed page data displayed in the window 401 is sent to the content analysis server 103. Thus, recommendation data with high similarities to the displayed page data that has been changed with time is provided to the user.

It should be noted that when a vector of displayed page data is generated, clustering for page data of all documents managed by the content management server 102 and clustering for the displayed page data may be performed.

Moreover, according to the embodiment described above, the document operation detected in the step S801 is not limited to opening a document, but may be an operation that changes displayed page data such as turning a page or editing. In the case where such an operation is detected, when the CPU 211 determines in the step S805 the operation that closes the displayed document has not been detected, the process returns to the step S801 without the process in the step S806 being carried out. This enables the terminal apparatus 101 to, in response to detection of the operation that changes displayed page data, provide page data with high similarities to the changed displayed page data to the user.

According to the embodiment described above, to increase throughput speed by reducing the amount of processing in vectoring features of page data to a minimum extent possible, features of page data are vectored based on text data of each piece of page data, but the present invention is not limited to this. For example, features of page data may be vectorized based on at least some image information constituting the page data. In the case where the image information is used, the content analysis server 103 vectorizes the page data by obtaining image feature amounts.

Moreover, according to the embodiment described above, although objects are clustered and recommended on a page-by-page basis, objects may be clustered and recommended with respect to each text component e.g. each chapter, each section, and each paragraph of a text, and also, objects may be clustered and recommended using both pages and text components. In the case where objects are clustered and recommended with respect to each text component, information on each text component is recorded in place of the page numbers 704 in the partial data information management table 700.

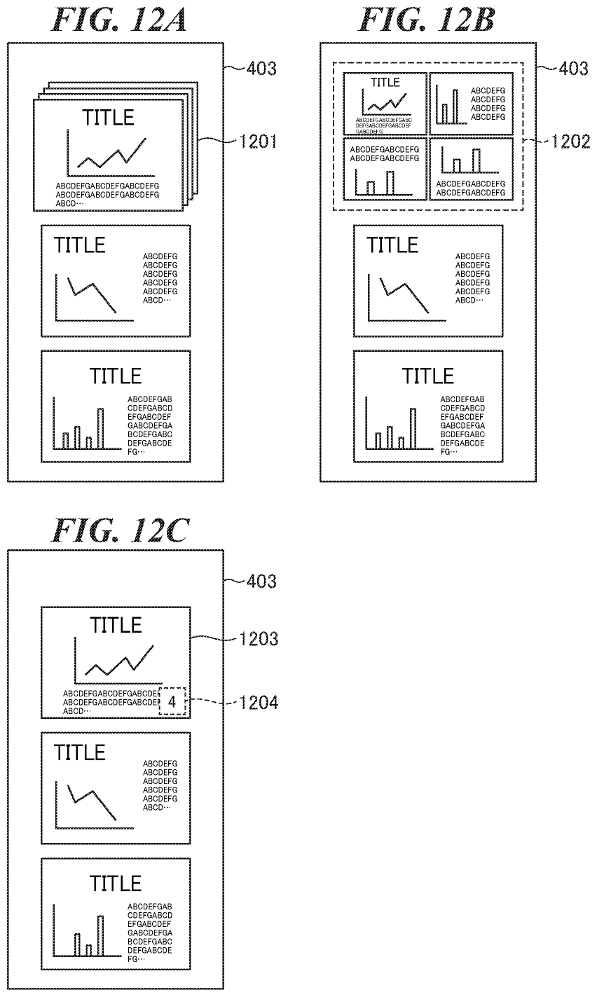

In the embodiment described above, when, for example, data on a chapter consisting of a plurality of pages is selected as an object to be recommended, a recommendation image indicating that the object to be recommended is data consisting of the plurality of pages may be displayed on the terminal apparatus 101. For example, an image 1201 showing several pages overlapping one another is displayed as shown in FIG. 12A, reduced thumbnails of respective pieces of page data are displayed as shown in FIG. 12B, or an image 1204 is displayed in a manner being superimposed on a thumbnail 1203 of a first page of the chapter as shown in FIG. 12C. The image 1204 includes a number of pages of the object to be recommended. This informs the user that the object to be recommended is the data consisting of the plurality of pages.

In the embodiment described above, the content providing system should not always have the above arrangement, but the terminal apparatus 101 may be equipped with the functions of the content analysis server 103 to carry out the processes in FIGS. 5 and 9.

Moreover, in the embodiment described above, objects to be recommended (candidates to be provided) selected based on results of clustering on a page-by-page basis may be narrowed down based on results of clustering on a document-by-document basis.

For example, if results of clustering on a page-by-page basis are used to select objects to be recommended, there may be cases where data unsuitable as a reference for editing, for example, data that is not closely related to a displayed document is selected as an object to be recommended.

To address this, in the present embodiment, objects to be recommended selected based on results of clustering on a page-by-page basis are narrowed down based on results of clustering on a document-by-document basis.

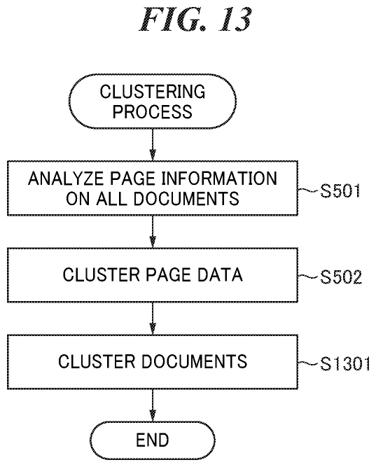

FIG. 13 is a flowchart showing the procedure of a variation of the clustering process in FIG. 5. The process in FIG. 13 is also implemented by the CPU 201 executing a program stored in the ROM 202 or the storage device 204. The process in FIG. 13 is also carried out, for example, when a new document is registered in the content management server 102 or when a predetermined time period set in advance has elapsed.

Referring to FIG. 13, the document analysis module 302 carries out the processes in the steps 5501 and 5502. Next, the document analysis module 302 vectorizes features of each entire document. Specifically, the document analysis module 302 obtains all pieces of text data constituting a document, and based on the obtained pieces of text data, vectorizes the document in the same manner as in the step S502. Then, the document analysis module 302 clusters each document (step S1301). The results of clustering are managed in a document information management table 1400 in FIG. 14. The document information management table 1400 is comprised of vector IDs 1401, document IDs 1402, document addresses 1403, and cluster IDs 1404. Identifiers for identifying respective feature vectors are recorded as the vector IDs 1401. The document IDs 1402 correspond to the document IDs 702 in the partial data information management table 700, and identifiers for identifying respective documents managed by the content management server 102 are recorded as the document IDs 1402. Addresses indicating storage locations of the respective documents managed by the content management server 102 are recorded as the document addresses 1403. Identifiers for identifying content clusters with which the respective documents managed by the content management server 102 are associated are recorded as the cluster IDs 1404. It should be noted that in the present embodiment, identifiers distinguishable from clusters with which the respective pieces of page data are associated in the step S502 are assigned to the content clusters. For example, as shown in FIG. 7, serial numbers with an initial “C” are assigned as the identifiers to the clusters with which the respective pieces of page data are associated, and as shown in FIG. 14, serial numbers with an initial “CD” are assigned as the identifiers to the content clusters.

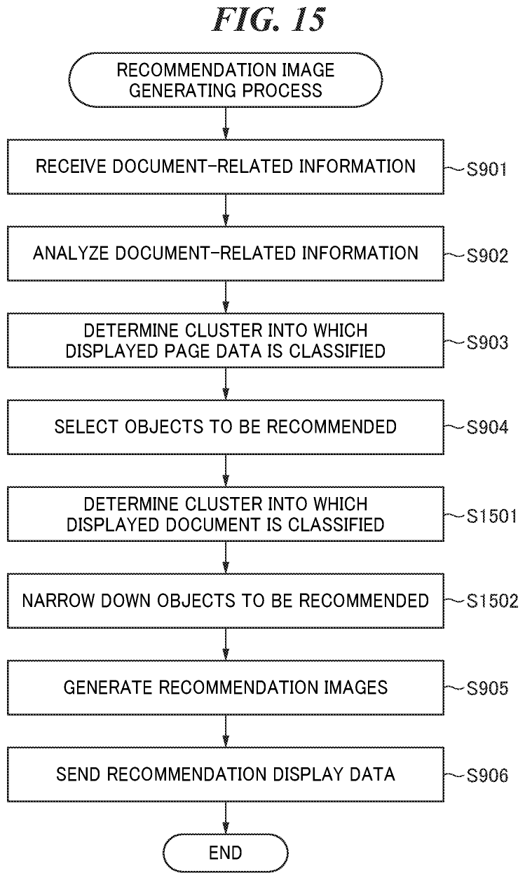

FIG. 15 is a flowchart showing the procedure a variation of the recommendation image generating process in FIG. 9. The process in FIG. 15 is also implemented by the CPU 201 executing a program stored in the ROM 202 or the storage device 204.

Referring to FIG. 15, the CPU 201 carries out the processes in the steps S901 to 5904. Next, the CPU 201 causes the document analysis module 302 to determine a content cluster into which the displayed document is classified (step S1501). In the step S1501, the same process as the process carried out on the displayed page data in the step S903 is carried out on the displayed document. Then, the CPU 201 causes the document analysis module 302 to narrow down the objects to be recommended selected in the step S904 based on the result of the determination in the step S1501 (step S1502). For example, when it is determined in the step S903 that the cluster into which the displayed page data is classified is a cluster C004, page data corresponding to vectors IDs (document IDs) P00001 (D00001), P00003 (D00002), and P00006 (D00003) is selected as objects to be recommended based on the partial data information management table 700. On the other hand, when it is determined in the step S1501 that the content cluster into which the displayed document is classified is a cluster CD03, the objects to be recommended are narrowed down to page data corresponding to vectors ID (document ID) P00006 (D00003) based on the document information management table 1400. It should be noted that when the content cluster determined in the step S1501 is not included in the document information management table 1400, for example, the objects to be recommended are not narrowed down, or alternatively, the objects to be recommended are narrowed down to documents belonging to a content cluster with which the largest number of documents are associated. After that, the CPU 201 carries out the processes in the step S905 and the subsequent steps.

According to the embodiment described above, objects to be recommended selected based on results of clustering on a page-by-page basis may be narrowed down based on results of clustering on a document-by-document basis. As a result, recommendation data that is more suitable as a reference for editing is provided to the user.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-184591, filed Sep. 28, 2018, which is hereby incorporated by reference herein in its entirety.

What is claimed is:

1. A content providing system that provides a content registered in advance to an information processing apparatus that is operated by a user, comprising at least one processor and/or a circuit configured to function as:
an analysis unit that analyzes plural pieces of partial data constituting the registered content;
a management unit that manages each piece of the partial data in association with any of a plurality of predetermined clusters;
a cluster determination unit that determines a cluster into which displayed partial data displayed on the information processing apparatus is classified; and
a content providing unit that provides partial data associated with the determined cluster among the plural pieces of partial data constituting the registered content to the information processing apparatus.

2. The content providing system according to claim 1, wherein the partial data is data corresponding to each of pages constituting the content comprising a plurality of pages.

3. The content providing system according to claim 1, wherein the partial data is data corresponding to each of chapters constituting the content comprising a plurality of chapters.

4. The content providing system according to claim 1, wherein the partial data is data corresponding to each of sections constituting the content comprising a plurality of sections.

5. The content providing system according to claim 1, wherein the partial data is data corresponding to each of paragraphs constituting the content comprising a plurality of paragraphs.

6. The content providing system according to claim 1, comprising the processor and/or a circuit configured to further function as an image transmission unit that transmits a thumbnail of partial data associated with the determined cluster among the plural pieces of partial data constituting the registered content to the information processing apparatus.

7. The content providing system according to claim 6, comprising the processor and/or a circuit configured to further function as:
another management unit that manages the registered content in association with any of a plurality of predetermined content clusters; and
a content cluster determination unit that determines a content cluster into which a displayed content comprising displayed partial data displayed on the information processing apparatus is classified,
wherein candidates that are selected based on the determined cluster and are to be provided to the information processing apparatus are narrowed down based on the content cluster.

8. The content providing system according to claim 7, comprising:
a content management server that manages the registered content; and
a content analysis server,
wherein the content analysis server comprises at least one processor and/or a circuit configured to function as the analysis unit, the management unit, the cluster determination unit, the image transmission unit, the other management unit, and the content cluster determination unit.

9. A content providing method of providing a content registered in advance to an information processing apparatus that is operated by a user, comprising:
analyzing plural pieces of partial data constituting the registered content;
managing each piece of the partial data in association with any of a plurality of predetermined clusters;
determining a cluster into which displayed partial data displayed on the information processing apparatus is classified; and
providing partial data associated with the determined cluster among the plural pieces of partial data constituting the registered content to the information processing apparatus.

10. An information processing apparatus that carries out data communications with a content management server that manages a registered content and a content analysis server that analyzes plural pieces of partial data constituting the content, comprising at least one processor and/or a circuit configured to further function as:
a detecting unit that detects a user's operation on a document;
a transmission unit that transmits document-related information including information indicating displayed partial data displayed on the information processing apparatus to the content analysis server;
a receiving unit that receives an image representing partial data corresponding to the document-related information among the plural pieces of partial data constituting the content;
a display unit that displays the image; and
an obtaining unit that obtains partial data corresponding to the image among the plural pieces of partial data constituting the content.

11. The information processing apparatus according to claim 10, wherein the partial data is data corresponding to each of pages constituting the content comprising a plurality of pages.

12. The information processing apparatus according to claim 10, wherein the partial data is data corresponding to each of chapters constituting the content comprising a plurality of chapters.

13. The information processing apparatus according to claim 10, wherein the partial data is data corresponding to each of sections constituting the content comprising a plurality of sections.

14. The information processing apparatus according to claim 10, wherein the partial data is data corresponding to each of paragraphs constituting the content comprising a plurality of paragraphs.

15. The information processing apparatus according to claim 10, wherein the transmission unit transmits other document-related information including information indicating displayed partial data, which is displayed on the information processing apparatus when a predetermined time period set in advance has elapsed since the document-related information was sent to the content analysis server, to the content analysis server.

16. The information processing apparatus according to claim 10, wherein upon detecting a user's operation to change the displayed partial data, the transmission unit transmits document-related information including information indicating the changed displayed partial data to the content analysis server.

17. A non-transitory computer-readable storage medium storing a program for executing an application installed in an information processing apparatus that carries out data communications with a content management server that manages registered content and a content analysis server that analyzes plural pieces of partial data constituting the content,
the application provides control to:
detect a user's operation on a document;
transmit document-related information including information indicating displayed partial data displayed on the information processing apparatus to the content analysis server;
receive an image representing partial data corresponding to the document-related information among the plural pieces of partial data constituting the content;
display the image; and
obtain partial data corresponding to the image among the plural pieces of partial data constituting the content.
